(19) United States
(12) Patent Application Publication
(10) Pub. No.: US 2010/0293772 A1
(43) Pub. Date: Nov. 25, 2010

(54) Method of manufacturing the backrest, seat-cushion and armrest of sofa by using bow-shaped springs

(76) Inventor: Xingang Pan, Qingdao (CN)

Correspondence Address: JACOBSON HOLMAN PLLC, 400 SEVENTH STREET N.W., SUITE 600, WASHINGTON, DC, 20004, US

(21) Appl. No.: 12/308,663

(22) PCT Filed: May 12, 2007
(86) PCT No.: PCT/CN2007/000779

§ 371 Date: Dec. 19, 2008

(30) Foreign Application Priority Data
Jun. 19, 2006 (CN) 200610045054.5

(51) Int. Cl. B23P 11/00

(52) U.S. Cl. 29/428

(57) ABSTRACT

A method of manufacturing the backrest, seat-cushion and armrest of sofa using bow-shaped springs, includes such steps as continuously curving the steel wire to become S-shaped bands, curved top in the middle, and both sides with V-shaped surface and Z-shaped surface separately; parallel arranging the bow-shaped springs, fixing the both ends respectively in the both sides of the back or armrest of sofa, connecting them to the quadrangular steel wire frames, using straight wire to get the bow-shaped springs and quadrangular steel wire frames together in the middle, filling the bow-shaped springs with filler, and covering sofa with surficial fabrics.

### TECHNICAL FIELD

This invention relates to the manufacturing improvement of sofa and chair, and more particularly, to the manufacturing method of back-cushion and armrest of sofa by spring bow-shaped, which is used for all kinds of furniture with software structure, such as the seat in spacecrafts, trains, automobiles; the bedsides, chairs and sofa in homes as well as in office.

### BACKGROUND OF THE INVENTION

Sofa in the early development whose back-cushion was made by cylindrical spring, could be use a long time with good flexibility, no deformation, good air permeability and environment friendly. But cylindrical spring sofa and seat was fixed by hemp rope which easy to wear. This kind of sofa is time-consuming and laborious in the production process in which the high-level technical personnel was needed. In order to adapt to change of the style of sofa, it also needs a variety of sizes and shapes of cylindrical spring which is not suitable for sofa arm. It was replaced by foam sofa, because of its complexity of the process, high cost and easily damaged. Foam sofa has captured the market with its briefly process and low price and made the cylindrical spring sofa withdraw from the market. It's the second period of sofa sector.

Foam sofa has been recognized gradually in the course of the use of it. The flexible foam sofa relies on foam's own flexible. Its shortcomings such as lack of flexibility, poor ventilation, smelly, easy deformation, aging fast, detrimental to human health, difficult to degradation is fatal because of its the production at the expense of the environment and human health. As it is known, 90% soft structure of the furniture in the world use Polyurethane foam plastic. Abandoned plastic foam sofa is about 70,000,000 just in our country which made it difficult to protect our environment.

In order to change the monopoly of foam sofa, I've designed a kind of bow-shaped spring for sofa and chair, which take the existing problems of cylindrical spring sofa and foam sofa into account. This design has been granted a patent (cn 2005 3 0091056.4). The invention aims to product the back-cushion and armrest of sofa with bow-shaped spring and to seek its manufacturing effectiveness.

### DISCLOSURE OF THE INVENTION

In view of problems described above, the purpose of this invention is to provide a manufacturing method of the backrest, seat-cushion and armrest of sofa using bow-shaped spring. Because the bow-shaped spring has a fixed-structure, and combines the advantages of cylindrical spring sofa and foam sofa such as briefly process, low price, good flexibility, no deformation, good air permeability and environment friendly, the use of comfort and long life. The further purpose of this invention is to produce sofa seat-cushion, backrest and armrest by using one kind of spring.

To solve the said problems, the present invention adopts herein below technical solution: continuously curving the steel wire to become S-shaped bands, curved top in the middle, and both sides with V-shaped surface and Z-shaped surface separately; parallel arranging the bow-shaped springs, fixing the spring ends respectively in the both sides of the bottom plate of the back-cushion or armrest of sofa, connecting them to the quadrangular steel wire frames, using straight wire to get the bow-shaped springs and quadrangular steel wire frames together in the middle, filling the bow-shaped springs with filler, and covering sofa with surficial fabrics.

Said the bottom plate of the backrest, seat-cushion or armrest of sofa is rectangular steel plate that has square holes stamped in the middle so to be [symbol] -shaped or [symbol] -shaped frame, which pawls are stamped around the border of the plate for fixing the bow-shaped springs, the filler and the surficial fabrics.

Said the bottom plate of the backrest, seat-cushion or armrest of sofa is rectangular plastic injection plate, which pawls are set around the border of the plate for fixing the bow-shaped springs, the filler and the surficial fabrics.

Said filler has multilayers, which includes cloth, brown silk cushion, cotton pads and lining from inside to outside at least.

One side of said Z-shaped surface of bow-shaped springs is higher than the other side, which the higher side connects with the front of the bottom plate of the sofa seat-cushion, the lower connects with the back of the bottom plate of the sofa seat-cushion, and the front of the sofa seat-cushion covered by surficial fabrics is inclined forward.

Said curved top of the bow-shaped springs is set a concave, and one side of said Z-shaped surface of bow-shaped springs is higher than the other side, which the higher side connects with the bottom of the bottom plate of the sofa backrest, the lower connects with the top of the bottom plate of the sofa backrest, and the front of the sofa backrest covered by surficial fabrics is curved.

Two ends of said bow-shaped springs are U-shape, which the U-shaped ends insert among the three neighboring pawls for fixing when using steel or plastic plates as the bottom plates.

This invention has some advantages and positive effect compared with the prior art.
1) This invention combines the advantages of cylindrical spring sofa and foam sofa such as briefly process, low price, good flexibility, no deformation, good air permeability and environment friendly, the use of comfort and long life. The bow-shaped springs are made of steel wire, the lining are made of cotton and palm hill, therefore, it did not result in pollution and can be recycling or reuse after the end of life, which meet our development goals of independent innovation, environmental protection and recycling economy.
2) The bow-shaped spring is more flexible compared with the cylindrical. The innovation of producing the backrest, seat-cushion, and armrest of the sofa using the same spring made the production process more simple and convenient, the use more comfortable and establish a new method for sofa manufacturer.
3) Fixing the bow-shaped spring in the bottom framework and using the rectangular wire frames and the straight wire to get each of the bow-shaped spring and the rectangular wire frames together made frame reasonable and convenient without dislocation in its long life.
4) Processing methods in this invention is more convenient, production method is more simple and cost lower. Therefore this method is easy to promote.

### BRIEF DESCRIPTION OF THE DRAWINGS

FIG. 1 is a three-dimensional view of the bow-shaped spring of the sofa according to this invention

FIG. 2 is a three-dimensional view of the bottom plate of the seat-cushion and backrest of the sofa according to this invention

FIG. 3 is a three-dimensional view of the bow-shaped spring connected with the bottom plate of the seat-cushion of the sofa according to this invention

FIG. 4 is a three-dimensional view of the cross-section plane of the seat-cushion of the sofa according to this invention

### DESCRIPTION OF THE PREFERRED EMBODIMENTS

The back-cushion of the sofa we stated above is backrest and seat-cushion of sofa and chairs, and the bedsides.

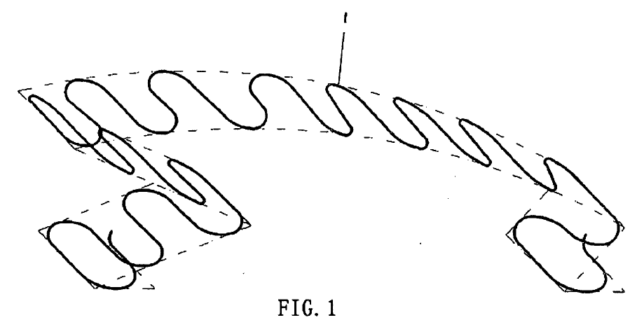

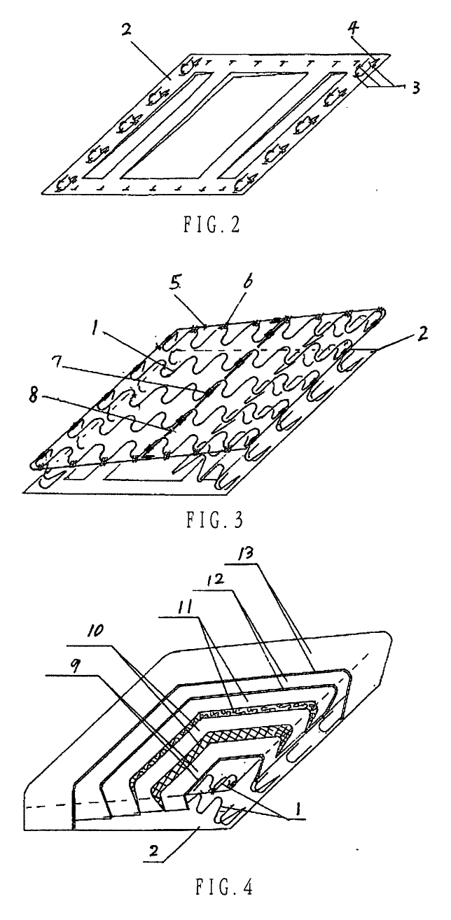

According to FIG. 1 to FIG. 4, the bow-shaped spring 1 for producing seat-cushion of the sofa is made by continuously curving the steel wire to become S-shaped bands, curved top in the middle, and both sides with V-shaped surface and Z-shaped surface separately. One side of said Z-shaped surface of bow-shaped springs 1 is higher than the other side. Said the bottom plate 2 of the seat-cushion of sofa is rectangular steel plate that has square holes stamped in the middle so to be [symbol] -shaped or [symbol] -shaped frame, which pawls 3 are stamped around the border of the plate 2 for fixing the bow-shaped springs 1, the filler and the surficial fabrics 13. Arrange the bow-shaped springs 1 parallel vertically. The higher side connects with the front of the bottom plate 2 of the sofa seat-cushion, and the lower connects with the back of the bottom plate 2 of the sofa seat-cushion. The quadrangular steel wire frames 5 connect the border of the bow-shaped springs 1 parallel by using steel wire fastener 6, which the bow-shaped springs 1 and the quadrangular steel wire frames 5 get together in the middle by using the straight wire 8 with fastener 7. Fill the bow-shaped springs 1 with filler, and finally cover sofa with surficial fabrics 13. Using pawls 3 around the border of the plate 2 fix the border of the filler and the surficial fabrics 13. The front of the seat-cushion covered by surficial fabrics is inclined forward to avoid hurting. Said filler has multilayers, which includes cloth 9, brown silk cushion 10, cotton pads 11 and lining 12 from inside to outside at least.

Use the bow-shaped spring 1 and bottom plate 2 said above for producing the backrest of sofa. The curved top of the bow-shaped spring 1 may be set a concave. The higher side connects with the bottom of the bottom plate 2 of the sofa backrest, and the lower connects with the top of the bottom plate 2 of the sofa backrest. The fixing the bow-shaped spring 1 and the filler and the surficial fabrics 13 are similar to those of the seat-cushion of sofa. The front side of the backrest covered by surficial fabrics is curved suit to rest.

4-12 bow-shaped springs 1 are needed to produce the seat-cushion and the backrest of the sofa, while 1-2 bow-shaped springs 1 are needed to produce the armrests of the sofa. The producing method of the armrests is similar to that of the seat-cushion.

The bottom plate of the backrest, seat-cushion and armrests of the sofa said above may be made of plastic injection board. The injection molding pawls around the border of the bottom plate is used to fix the bow-shaped springs 1. And the nail is used to fix the filler and the surficial fabrics.

The bottom plate of the backrest, seat-cushion and armrests of the sofa said above may be made of rectangular board. And the nail is used to fix the bow-shaped springs 1, the filler and the surficial fabrics 13.

The both ends 4 of the bow-shaped spring 1 are the U-shape. Using steel or plastic injection molding board as the bottom plate, the U-shaped ends 4 of the bow-shaped springs insert among the three neighboring pawls for fixing, which method is simple and fastness.

Set the bow-shaped springs 1 side-by-side vertically when producing the backrest, the seat-cushion and the armrest of trapezium-shaped sofa. The space among the higher sides of the bow-shaped springs 1 should be larger than that of the lowers, which is good to mount and adjust.

Fix the backrest, the seat-cushion and the armrests of the sofa to the base of the sofa. The process of the producing method is finished.

Technical solution of this invention can be used for all kinds of soft-structure of furniture, such as the seat in spacecrafts, trains, automobiles; the bedsides, chairs and sofa in homes; and the business chair and sofa in office and so on.

Although this invention has been described with reference to the foregoing preferred embodiments, it will be understood that the invention is not limited to the details thereof. Various equivalent variations and modifications can still be occurred to those skilled in this art in view of the teachings of this invention. Thus, all such variations and equivalent modifications are also embraced within the scope of this invention as defined in the appended claims.

1. A method of manufacturing the backrest, seat-cushion and armrest of sofa using bow-shaped springs, comprising:
continuously curving the steel wire to become S-shaped bands, curved top in the middle, and both sides with V-shaped surface and Z-shaped surface separately; parallel arranging the bow-shaped springs, fixing the spring ends respectively in the both sides of the bottom plate of the back-cushion or armrest of sofa, connecting them to the quadrangular steel wire frames, using straight wire to get the bow-shaped springs and quadrangular steel wire frames together in the middle, filling the bow-shaped springs with filler, and covering sofa with surficial fabrics.

2. The method of claim 1, wherein said the bottom plate of the backrest, seat-cushion or armrest of sofa is rectangular steel plate that has square holes stamped in the middle so to be [symbol] -shaped or [symbol] -shaped frame, which pawls are stamped around the border of the plate for fixing the bow-shaped springs, the filler and the surficial fabrics.

3. The method of claim 1, wherein said the bottom plate of the backrest, seat-cushion or armrest of sofa is rectangular plastic injection plate, which pawls are set around the border of the plate for fixing the bow-shaped springs, the filler and the surficial fabrics.

4. The method of claim 1, wherein said filler has multilayers, which includes cloth, brown silk cushion, cotton pads and lining from inside to outside at least.

5. The method of claim 3, wherein said filler has multi-layers, which includes cloth, brown silk cushion, cotton pads and lining from inside to outside at least.

6. The method of claim 1, wherein one side of said Z-shaped surface of bow-shaped springs is higher than the other side, which the higher side connects with the front of the bottom plate of the sofa seat-cushion, the lower connects with the back of the bottom plate of the sofa seat-cushion, and the front of the sofa seat-cushion covered by surficial fabrics is inclined forward.

7. The method of claim 5, wherein one side of said Z-shaped surface of bow-shaped springs is higher than the other side, which the higher side connects with the front of the bottom plate of the sofa seat-cushion, the lower connects with the back of the bottom plate of the sofa seat-cushion, and the front of the sofa seat-cushion covered by surficial fabrics is inclined forward.

8. The method of claim 1, wherein Said curved top of the bow-shaped springs is set a concave, and one side of said Z-shaped surface of bow-shaped springs is higher than the other side, which the higher side connects with the bottom of the bottom plate of the sofa backrest, the lower connects with the top of the bottom plate of the sofa backrest, and the front of the sofa backrest covered by surficial fabrics is curved.

9. The method of claim 5, wherein Said curved top of the bow-shaped springs is set a concave, and one side of said Z-shaped surface of bow-shaped springs is higher than the other side, which the higher side connects with the bottom of the bottom plate of the sofa backrest, the lower connects with the top of the bottom plate of the sofa backrest, and the front of the sofa backrest covered by surficial fabrics is curved.

10. The method of claim 2, wherein two ends of said bow-shaped springs are U-shape, which the U-shaped ends insert among the three neighboring pawls for fixing when using steel or plastic plates as the bottom plates.
